(19) United States
(12) Patent Application Publication
(10) Pub. No.: US 2010/0118242 A1
(43) Pub. Date: May 13, 2010

(54) PHASE MODULATOR SYSTEM COMPRISING A BEAM SPLITTER AND A LINEAR POLARISATION MODE PHASE MODULATOR AND METHOD FOR SEPARATING A LIGHT BEAM TRAVELLING TOWARD AND REFLECTED BACK FROM SUCH A PHASE MODULATOR

(75) Inventors: Attila Barócsi, Budapest (HU); Gábor Erdei, Budapest (HU); Pál Koppa, Budaoers (HU); Emoeke Loerincz, Budapest (HU); Judit Reményi, Budapest (HU); Ferenc Ujhelyi, Mogyorod (HU)

Correspondence Address: Baker Donelson Bearman, Caldwell & Berkowitz, PC, 555 Eleventh Street, NW, Sixth Floor, Washington, DC, 20004, US

(73) Assignee: BAYER INNOVATION GMBH, Duesseldorf (DE)

(21) Appl. No.: 12/525,997

(22) PCT Filed: Jan. 24, 2008
(86) PCT No.: PCT/EP2008/000518

§ 371 Date: Sep. 25, 2009

(30) Foreign Application Priority Data
Feb. 6, 2007 (HU) P 07 00132

(51) Int. Cl. G02F 1/1335; G02F 1/01

(52) U.S. Cl. 349/119; 359/238

(57) ABSTRACT

The object of the invention is a phase modulator system comprising a beam splitter and a reflection mode phase modulator suitable for modulating linearly polarised light of at least one specific polarisation state while maintaining said polarisation state. The beam splitter and the phase modulator are arranged along an optical path of a light beam. The beam splitter is a polarisation beam splitter and the phase modulator system further comprises an optical rotator being arranged along the optical path between the polarisation beam splitter and the phase modulator, and rotating the polarisation state of the light beam by 45° in a given sense, wherein the polarisation state of the light beam incident upon the phase modulator corresponds to said specific polarisation state. The invention further relates to a method for separating an input light beam from a phase modulated light beam in a phase modulator system comprising a phase modulator operable in reflection mode and suitable for modulating linearly polarised light of at least one specific linear polarisation state while maintaining said specific linear polarisation state. The method comprises the steps of
a)

The present invention relates to an optical arrangement for reducing the output power loss of a phase modulator system comprising a reflection mode phase modulator suitable for modulating linearly polarised light leaving its polarisation state unchanged. The invention further relates to a method for separating a light beam travelling toward and reflected back from such a phase modulator.

Known phase modulator systems can incorporate various kinds of phase modulators including transmission mode phase modulators (transmitting incident light) and reflection mode phase modulators (reflecting incident light). The present invention focuses on the application of reflection mode phase modulators. Certain applications require special phase modulators, which reflect or transmit an incident light beam having a specific polarisation maintaining this specific polarisation. This specific polarisation can be a linear polarisation or a circular polarisation. The two kinds of phase modulators will be referred to as linear and circular polarisation mode phase modulators (LPM and CPM phase modulators) accordingly. Such phase modulators are commercially available and are commonly used in various applications.

Less expensive LPM and CPM phase modulator constructions generally require the incident light beam to be perpendicular to the surface of the phase modulator, hence, in the case of reflection mode phase modulators the incident light beam is reflected back along the same optical path. In most applications it is necessary to separate the reflected phase modulated light beam from the incident light beam as only the phase modulated light beam is to be coupled out for further use.

In conventional phase shifter arrangements the separation of an incident light beam and a reflected modulated light beam is generally achieved by using a neutral beam splitter. Such an arrangement is described for example by Jacek Kacperski et al. (Optics Express 9664, Vol. 14, No. 21) where an LCoS (liquid crystal on silicon) display is used as an LPM phase modulator.

The input light beam passes through a polarisation controller, which is a λ/2 plate to obtain the required linear polarisation state and then passes through a neutral beam splitter directing only half of the beam onto the LCoS display. The reflected modulated beam passes through the beam splitter again, meaning that only a quarter of the original beam can be coupled out of the system this high output loss being the drawback of the conventional LPM phase modulator systems.

U.S. Pat. No. 5,539,567 patent discloses a phase modulator system for solving the problem of separating an incident light beam from a reflected light beam when illuminating a CPM phase modulator with circularly polarised light. In order to create the circularly polarised light an input light beam is directed into a polarised beam splitter (PBS) from where the p-polarised component of the light beam is internally reflected and exits the PBS toward a ¼ wave plate provided to convert the linearly polarised light into circularly polarised light. The CPM phase modulator reflects back the circularly polarised light beam with its circular polarisation unchanged. As the light beam passes back through the ¼ wave plate its polarisation is converted back to linear polarisation but because the beam has passed through the ¼ wave plate twice its polarisation is now rotated by 90° and can therefore pass through the PBS. Hence the phase modulated output light beam exits the phase modulator system at a different location and angle as the input light.

The above described arrangement is not adapted for use together with an LPM phase modulator as the ¼ wave plate creates circularly polarised light rendering the beam unsuitable for the LPM phase modulator.

A similar low output loss optical arrangement would be desirable for use with an LPM phase modulator.

It is therefore an object of the invention to provide an optical arrangement for reducing the output loss of a phase modulator system comprising a reflection mode LPM phase modulator. It is a further object of the invention to provide a method for separating a light beam travelling to and reflected back from an LPM phase modulator.

The above objects are achieved by providing a phase modulator system according to claim 1 and by providing a method according to claim 8.

Further details of the invention will be apparent from the accompanying figures and exemplary embodiments.

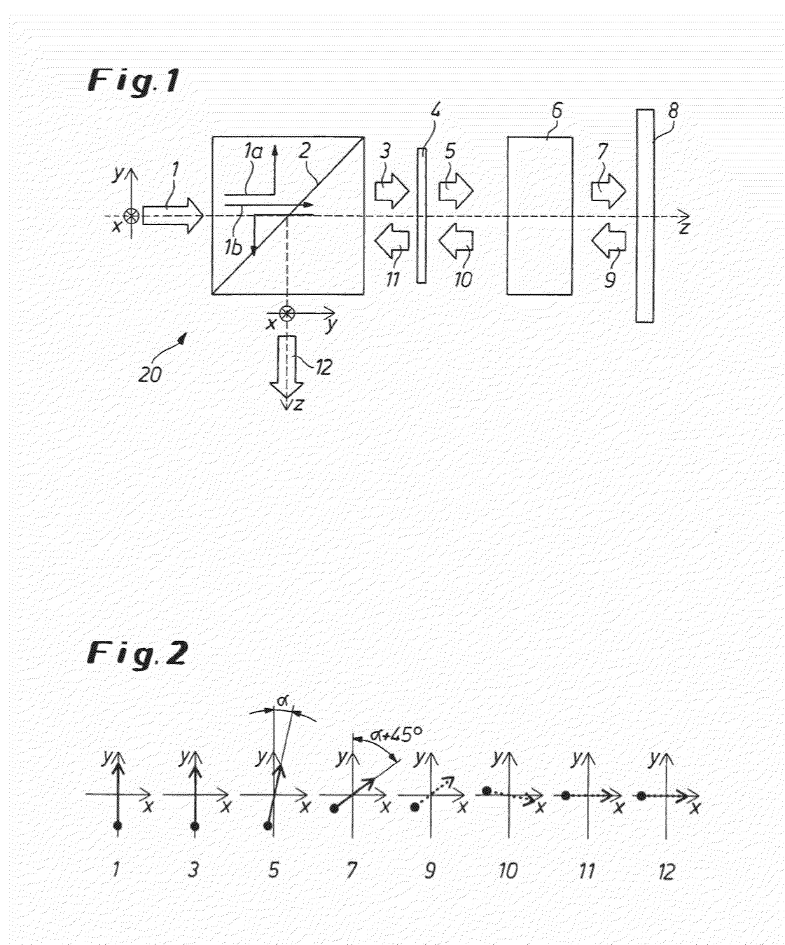

FIG. 1 is a schematic view of an exemplary embodiment of an optical phase modulator system according to the invention.

FIG. 2 is an illustrative diagram series showing the polarisation state of a light beam at different stages while passing through the phase modulator system.

FIG. 1 is a schematic view showing an exemplary embodiment of the optical phase modulator system 20 according to the invention. The phase modulator system 20 comprises a polarisation beam splitter (PBS) 2, a λ/2 plate 4, an optical rotator 6 and a reflection mode LPM phase modulator 8 arranged along an optical path of a light beam 1, 3, 5, 7, 9, 10, 11, 12 traversing the system 20.

The optical path can follow any desired line between the PBS 2 and the phase modulator 8 depending on the application. Creating the required optical path by means of mirrors, optical wave guides, etc. is well known in the art, and is therefore not discussed in further detail. In the context of the present invention an optical rotator is understood to be a polarisation rotator rotating the polarisation state of a linearly polarised light beam by a given angle in a given sense, i.e. the sense of rotation is regardless of the direction of light propagation. The rotational angle of the optical rotator 6 according to the invention is 45°. The optical rotator 6 can be for example any optically active material (chiral substance) with a suitably chosen thickness, or it can be a 45° Faraday rotator.

The λ/2 plate 4 on the other hand is a different type of polarisation rotator: the rotation of a light beam passing through a λ/2 plate back and forth is not cumulative, i.e. the sense of rotation is dependent on the direction of light propagation. As a result, the polarisation direction of linearly polarised light traversing back and forth such a plate will remain the same. The LPM phase modulator 8 can be for example a VAN (Vertically Aligned Nematic) mode liquid crystal, in one of its practical implementation form, liquid crystal on silicon (LCoS) structure.

An input light beam 1 is directed into the PBS 2 where it is divided into an s-polarised component 1a and a p-polarised component 1b. The s-polarised component 1a is reflected and exits the system or alternatively, it can be coupled out for further use, while the p-polarised component 1b passes through the PBS 2 and exits as light beam 3. In another preferred embodiment a p-polarised input light beam 1 is created prior to being directed into the PBS 2 and passes through the PBS 2 without any loss.

According to a preferred embodiment the exiting p-polarised light beam 3 is made to pass through the λ/2 plate 4. The λ/2 plate 4 can be arranged anywhere along the optical path between the PBS 2 and the phase modulator 8 and serves to adjust the angle of polarisation of the exiting light beam 5 to the phase modulator 8. When passing the λ/2 plate 4 in the forward direction the linear polarisation of the p-polarised light beam 3 is rotated at a given angle to match the required polarisation angle of the phase modulator 8.

The light beam 5 propagates to the optical rotator 6, which rotates the polarisation by 45°. As a result of having passed through the λ/2 plate 4 and the 45° optical rotator 6 the polarisation of the light beam 7 incident on the LPM phase modulator 8 corresponds to the specific polarisation state of the phase modulator 8, which is unchanged when reflecting back the incident light beam 7, while the phase of the light beam 7 is being modulated. When the reflected phase modulated light beam 9 travelling in the backward direction is again rotated by 45° by the optical rotator 6 the polarisation of the exiting light beam 10 will be perpendicular to the polarisation of the light beam 5. Further more as the light beam 10 passes the λ/2 plate 4 in the backward direction its polarisation is rotated back by the same given angle as when passing it in the forward direction. Thus an s-polarised light beam 11 is obtained, which is reflected from the PBS 2 when re-entering it and can hence be coupled out of the phase modulator system 20 in form of an output s-polarised light beam 12 at a different location and angle as that of the input light beam 1 entering the system 20.

The polarisation states of the light beam (1, 3, 5, 7, 9, 10, 11, 12) passing through the phase modulator system 20 are illustrated on the diagrams of FIG. 2. The arrows indicate the direction of the polarisation (y axis corresponding to the vertically polarised or p-polarised state) while the numerals below each diagram indicate the reference numeral of the relating light beam. Accordingly the first diagram shows the polarisation state of the input light beam 1, which is a p-polarised (vertically polarised) light beam according to a preferred embodiment. The light beam 3 exiting the PBS 2 has the same polarisation as the input light beam 1 as can be seen from the second diagram. The third diagram shows that the polarisation of the light beam 5 has been rotated by the λ/2 plate by a given angle a with respect to the polarisation state of the light beam 3. The required angle a can be easily set by changing the orientation of the λ/2 plate rotating it around the z axis. The polarisation of the light beam 7 is rotated by the optical rotator 6 in a clockwise sense by 45° with respect to the light beam 5, hence the polarisation of the light beam 7 is at an angle of a +45° from the original p-polarisation of the input light beam 1. The rotation angle a of the λ/2 plate is chosen such that the total rotation of the p-polarised beam results in a polarisation state corresponding to the specific polarisation state of the LPM phase modulator 8, which is reflected back unchanged. The polarisation state of the phase modulated light beams 9, 10, 11 and 12 travelling in the backward direction are depicted with dashed arrows to make the diagrams more comprehensible. As can be seen from the fifth diagram the polarisation of the light beam 9 reflected back from the LPM phase modulator 8 remains unchanged with respect to that of the incident light beam 7, while its phase has been modulated. When passing through the optical rotator 6 in the backward direction the polarisation of the light beam 10 is rotated in the same clockwise direction by another 45° which means that polarisation of the light beam 10 is at an angle of a +90° to the y axis since the sense of rotation of the optical rotator 6 is irrespective of the direction of propagation. This is not the case for the λ/2 plate, which rotates back the polarisation of the light beam 10 with the same angle a but this time in an anti-clockwise sense.

Thus the polarisation of the resulting light beam 11 is perpendicular to that of the original p-polarised input light beam 1. The s-polarised light beam 11 is therefore reflected back at an angle when re-entering the PBS 2, providing the phase-modulated s-polarised output light beam 12 as illustrated on the last diagram.

The role of the input and output light beams 1 and 12 together with the direction of propagation can be reversed, meaning that if an s-polarised light beam 11 is fed into the phase modulator system 20 at the output side of the PBS 2 a phase modulated p-polarised light beam 1 can be obtained at the input side.

The λ/2 plate 4 and the optical rotator 6 can be rotated around the optical axis of the system 20 in order to achieve better light transmission. However the overall transmission of the system 20 is determined mainly by the reflection rate of the phase modulator 8, which can be relatively large, generally around 70%. The speed of modulation is also determined by the phase modulator 8 and is generally as high as 6-9 ms. The LPM phase modulator 8 is preferably a pixel array type light modulator having a resolution of approximately 1920×1200 for example. If the phase modulator 8 is a VAN mode display the overall transmission change of the optical system in function of the phase modulation is rather small, in the above embodiment the total change of transmission is +1/−10% for a phase modulation of 1,3 π.

The λ/2 plate 4 can be omitted if the PBS 2 and the phase modulator 8 are aligned with respect to each other such that the polarised light beam 3 exiting the PBS 2 is at an angle of 45° to the specific polarisation state required by the phase modulator 8. However it is often not possible to mechanically align the components to the desired extent in this case post-assemblage matching of the components can be performed by inserting an appropriate λ/2 plate 4 anywhere along the optical path between the PBS 2 and the phase modulator 8. The rotation angle of the λ/2 plate is preferably between) (−45° and) (+45° even more preferably between) (−23°) and (+23°).

The above-described embodiments are intended only as illustrating examples and are not to be considered as limiting the invention. Various modifications will be apparent to a person skilled in the art without departing from the scope of protection determined by the attached claims.

1. A phase modulator system comprising
a beam splitter and
a reflection mode phase modulator suitable for modulating linearly polarised light of at least one specific polarisation state while maintaining said polarisation state,
wherein the beam splitter and the phase modulator are arranged along an optical path of a light beam,
wherein the beam splitter is a polarisation beam splitter and the phase modulator system further comprises
an optical rotator being arranged along the optical path between the polarisation beam splitter and the phase modulator, and rotating the polarisation state of the light beam travelling to and back from the phase modulator by a total of 90°,
wherein the polarisation state of the light beam incident upon the phase modulator corresponds to said specific polarisation state.

2. The phase modulator system according to claim 1, wherein a λ/2 plate is arranged along the optical path between the polarisation beam splitter and the phase modulator, the λ/2 plate rotating the polarisation state of the light beam travelling towards the phase modulator by a pre-chosen angle and rotating the polarisation state of the light beam travelling towards the polarisation beam splitter by the same angle but in the opposite sense.

3. The phase modulator system according to claim 2, wherein the λ/2 plate is arranged between the polarisation beam splitter and the optical rotator.

4. The phase modulator system according to claim 2, wherein the λ/2 plate is arranged between the optical rotator and the phase shifter.

5. The phase modulator system according to claim 1, wherein the optical rotator is an optically active substance.

6. The phase modulator system according to claim 1, wherein the optical rotator is a 45° Faraday rotator.

7. The phase modulator system according to claim 1, wherein the phase modulator is a pixel array type light modulator.

8. A method for separating an input light beam from a phase modulated light beam in a phase modulator system comprising a phase modulator operable in reflection mode and suitable for modulating linearly polarised light of at least one specific linear polarisation state while maintaining said specific linear polarisation state, said method comprising
a) providing a light beam having a first polarisation state by making an input light beam pass through a polarisation beam splitter;
b) rotating said first polarisation state of said light beam by 45° in a first sense by an optical rotator;
c) reflecting said light beam by the phase modulator to obtain a phase modulated reflected light beam, wherein the polarisation state of the light beam incident upon the phase modulator corresponds to said specific polarisation state;
d) rotating the polarisation state of the reflected light beam by 45° in said first sense by the optical rotator to obtain a light beam having a polarisation state orthogonal to said first polarisation state; and
e) separating said light beam having said second polarisation state from the input light beam by making the light beam pass through said polarisation beam splitter.

9. The method according to claim 8, wherein the method further comprises
f) rotating the polarisation state of the light beam travelling from the polarisation beam splitter to the phase modulator by α by a λ/2 plate; and
g) rotating the polarisation state of the light beam travelling from the phase modulator to the polarisation beam splitter by (−α) by said λ/2 plate,
α being an angle between (−45°) and (+45°).

10. The method according to claim 9, wherein step f) is performed between steps a) and b) and step g) is performed between steps d) and e).

11. The method according to claim 9, wherein step f) is performed between steps b) and c) and step g) is performed between steps c) and d).

12. The method according to any of claim 8, wherein the phase modulator is a pixel array type light modulator, preferably a vertically aligned nematic mode liquid crystal structure, even more preferably a vertically aligned nematic mode liquid crystal on silicon structure.

13. A method of claim 8 wherein the phase modulator is a vertically aligned nematic mode liquid crystal structure.

14. A method of claim 13, wherein the phase modulator is a vertically aligned nematic mode liquid crystal on silicon structure.

15. A system of claim 7, wherein the modulator is a vertically aligned nematic mode liquid crystal structure.

16. A system of claim 15, wherein the modulator is a vertically aligned nemtaic mode liquid crystal on silicon structure.
